(19) United States
(12) Patent Application Publication
(10) Pub. No.: US 2018/0134855 A1
(43) Pub. Date: May 17, 2018

(54) HARDNESS ADJUSTMENT OF THERMOPLASTIC ELASTOMER COMPOSITIONS BY COMBINATION OF THERMOPLASTS AND THERMOPLASTIC ELASTOMERS

(71) Applicant: KRAIBURG TPE GmbH & Co. KG, Waldkraiburg (DE)

(72) Inventor: Frieder Vielsack, Waldkraiburg (DE)

(21) Appl. No.: 15/816,831

(22) Filed: Nov. 17, 2017

Related U.S. Application Data
(63) Continuation of application No. PCT/DE2016/100242, filed on May 25, 2016.

(30) Foreign Application Priority Data
May 26, 2015 (DE) 10 2015 007 200.5

(51) Int. Cl. C08J 3/24; C08L 75/12; C08L 77/00; C08K 3/011

(52) U.S. Cl. CPC C08J 3/24; C08L 75/12; C08J 2300/26; C08K 3/011; C08J 2300/22; C08L 77/00

(57) ABSTRACT

Thermoplastic elastomer compositions have a hardness that can be adjusted by selecting combinations of thermoplasts and thermoplastic elastomers (TPEs). The thermoplastic elastomer compositions have very high temperature and chemical resistance with simultaneously very good mechanical parameters in a very broad Shore A hardness range of from 10 to 100 ShA with good processability. Furthermore, a process for producing thermoplastic elastomer compositions as well as a process for adjusting the hardness in the case of thermoplastic elastomer compositions is disclosed.

The present invention relates to thermoplastic elastomer compositions the hardness of which can be adjusted by means of selected combinations of thermoplasts and thermoplastic elastomers (TPEs). The thermoplastic elastomer compositions according to the invention are characterized by very high temperature and chemical resistance with simultaneously very good mechanical parameters in a very broad Shore A hardness range of from 10 to 100 ShA. Furthermore, the present invention also relates to a process for producing thermoplastic elastomer compositions as well as a process for adjusting the hardness in the case of thermoplastic elastomer compositions.

Mechanical parameters of thermoplastic elastomer compositions are for example tensile strength, elongation at break, compression set (CS) and swelling behaviour. The polymer class of the TPEs used for producing thermoplastic elastomer compositions combines the rubbery-elastic properties of elastomers with the advantageous processing properties of thermoplasts. This combination of properties opens up a wide variety of applications for the TPE materials, such as for example in automobile interiors and exteriors, for industrial devices, industrial tools, domestic appliances, medical consumables and devices, sanitary products such as toothbrushes, sporting goods, bathroom fittings, toys, containers for foodstuffs, to name but a few. The TPE materials take on properties such as a sealing and damping function or are used because of their pleasant feel and visual appearance.

Various classes of thermoplastic elastomers are known to a person skilled in the art. The TPEs described herein follow the definitions of DIN EN ISO 18064. The TPE classes are furthermore also described in “G. Holden, H. R. Kricheldorf, R. P. Quirk (Eds.), Thermoplastic Elastomers, Carl Hanser Verlag, 3rd Ed., Munich (2004)” or also under “http://en.wikipedia.org/wiki/Thermoplastic_elastomer”.

As described in DIN EN ISO 18064 under 3.1, TPEs are differentiated into two main classes. A TPE can consist of a polymer or a polymer mixture (blend). Furthermore, according to the named DIN EN ISO 18064, TPEs have properties that are similar to those of vulcanized rubber at the temperature of use, but can be processed and worked up at raised temperatures like a thermoplastic material.

TPEs which only consist of one polymer are almost exclusively block copolymers (for example TPEs based on polyamide (TPA), TPEs based on copolyester (TPC), TPEs based on polystyrene (TPS), TPEs based on polyurethane (TPU)). Polymer mixtures generally consist of an elastomer and a thermoplast (for example TPO (TPE based on polyolefin)). Furthermore, numerous mixed forms from both classes are known to a person skilled in the art. DIN EN ISO 18064 categorizes these under TPZ. Notwithstanding this standard, the designation TPZ will not be used in the present specification. Thus, commercially available TPSs are often not present as pure block copolymers, but more often as blends of styrene block copolymers and thermoplasts. Nevertheless, they are referred to (herein) as TPSs, notwithstanding the standard. Furthermore, within the class of the TPVs (TPEs based on vulcanized (cross-linked) rubber), there are vulcanized mixtures of thermoplasts and rubbers (or elastomers) which are present as random and/or alternating copolymers and those in which the rubbers are composed of block copolymers. In the case of TPVs based on block copolymers, the term TPV is more often used instead of TPZ. In these cases, the designation TPV is chosen in the present specification, notwithstanding DIN EN ISO 18064.

TPEs based on block copolymers (for example TPA, TPC, TPS) form phases (also domains) due to their internal molecular structure. Polymer mixtures can also form phases (also domains) and thus exhibit TPE behaviour. In both cases, hard, thermoplastic and soft, elastomeric domains are formed. When exposed to heat, the thermoplastic regions melt, and the TPE can then be processed like a thermoplast. On cooling, these hard regions solidify again, and the material then exhibits elastic properties of the soft domains.

In comparison with uncross-linked TPEs, TPVs from a particular polymer class generally exhibit improved mechanical properties such as for example tensile strength, elongation at break or compression set. In particular, the chemical resistance and thus the swelling behaviour of TPEs can be clearly improved by cross-linking. However, the gain in properties is accompanied by a higher complexity during the production. For example, cross-linking agents such as peroxides, sulphur compounds or phenolic resins must additionally be used. It must be ensured that the hard, thermoplastic phase is not also cross-linked or degraded. Degradation can for example occur with poor process management and when peroxides are used in the presence of PP (polypropylene) as thermoplast. In TPV production, precautions must in general be taken to prevent any sudden exothermic reactions during the vulcanization.

Since its discovery in the 1960s, the method of dynamic vulcanization has become established within the class of the TPVs. Here, cross-linking takes place during the intimate mixing of the molten thermoplastic and elastomeric phases in the presence of corresponding chemicals. Over the last few decades, a plurality of elastomer/thermoplast combinations with a wide variety of cross-linking systems have been used for TPV production (see also “G. Holden, H. R. Kricheldorf, R. P. Quirk (Eds.), Thermoplastic Elastomers, Carl Hanser Verlag, 3rd Ed., Munich (2004), p. 161 et seq.”).

In addition to conventional dynamic vulcanization, wherein one or more thermoplasts are combined with one or more elastomers, further methods of TPV production have been developed. For example, DE 10 2008 012 516 A1 describes a method in which, as elastomer, an α-olefin-vinyl acetate copolymer is reacted with a TPE to form a TPV together with a peroxidic cross-linker instead of with a thermoplast. Copolyesters (TPC) are used as TPEs. DE 692 27 140 T2 also describes thermoplastic elastomer compositions which contain, in addition to a rubber, a thermoplastic polyester elastomer and not a thermoplast as second component. DE 692 140 T2 describes the well-known problem that, in the case of too high a proportion of thermoplastic polyester elastomer, the flexibility and compressibility are inadequate. However, if the proportion of thermoplastic polyester elastomer is too low, the resulting composition has poor processability and a fluidity that is too low. Poor processability is generally accompanied by a poor durability, which decreases the processing window.

According to DIN EN ISO 18064, a TPV is described as a “thermoplastic rubber vulcanizate which consists of a mixture of a thermoplastic material with a common rubber and in which the rubber was cross-linked by the dynamic vulcanization process during the blending and mixing procedure”. In addition to the dynamic vulcanization, cross-linked elastomer particles can also be produced by a separate step and after that dispersed in a thermoplast. This type of TPV does not follow the definition of the named ISO standard, but belongs to the closer state of the art. DE 44 25 944 A1 describes, for example, mixtures of thermoplasts from the series polycarbonate, polystyrene-acrylonitrile, polymethyl methacrylate, polyoxymethylene and others with cross-linked ethylene-vinyl ester copolymers. Furthermore, it should be pointed out in this regard that the boundaries with so-called impact-modified thermoplasts are blurred. Here, for the modification of the thermoplasts, fairly small quantities of cross-linked elastomers are incorporated into thermoplastic matrices.

By “dynamic vulcanization” is meant the cross-linking of an elastomer during the process of melting and mixing in the presence of a thermoplast and optionally other additives.

A further way of producing TPE materials which have cross-linked elastomer domains is the mixing of pre-cross-linked elastomer particles with thermoplastic elastomers (TPEs). By “pre-cross-linked” elastomers is meant those which are already present cross-linked before the processing to form the thermoplastic elastomers. The products Chemigum® (NBR elastomer) and Sunigum® (cross-linked acrylate terpolymer) from Omnova, which are offered for sale as modifiers for TPCs or TPUs, may be named as examples.

Depending on the application, different property profiles are required for TPE materials. As a rule, not only one property, but a combination of several properties at a high level is required. For example, for engine or gearbox seals in the automotive sector, low compression set at high temperatures and simultaneously good resistance to mineral oils as well as adhesion to, for example, polyamide are required. The difficulties which confront a developer are opposing effects which make simultaneous achievement of all required properties at a very high level scarcely or not at all possible.

It is familiar to a person skilled in the art that for example uncross-linked TPEs, such as for example TPSs composed of styrene block copolymers and polypropylene (PP), exhibit good adhesion to PP, and very good tensile strengths and elongation at break properties can also be achieved. However, these TPE materials are only suitable up to continuous operating temperatures of up to approx. 80° C. If, for example, an adhesion to polar surfaces such as polyamide is required, a person skilled in the art must, for example, make polar modifications to the elastomer or to the thermoplast (see for example U.S. Pat. No. 8,193,273).

Through the use of vulcanized TPVs the temperature resistance and also the swelling behaviour can often be improved (EP 2 098 566 A1 and EP 2 098 570 B1); however this is often accompanied by losses in terms of the processability and elastic properties.

It is furthermore known to a person skilled in the art that the choice of the raw materials used significantly influences above all the chemical resistance, operating temperature and adhesion to other materials. A clear distinction must be made here between the different types of TPE. In the case of pure block copolymers such as TPC, TPU, TPA and TPS, the monomer units can be varied. In the case of the polymer mixtures such as TPS, TPO or TPV, both the monomer units of the thermoplasts and elastomers and also the combination of corresponding thermoplasts and elastomers itself can be varied. Here, reference may be made to “G. Holden, H. R. Kricheldorf, R. P. Quirk (Eds.), Thermoplastic Elastomers, Carl Hanser Verlag, 3rd Ed., Munich (2004)”. A person skilled in the art is often limited in the possible combinations by incompatible raw material combinations, above all in the case of the TPEs which consist of polymer blends.

In order to be able to successfully satisfy an application or field of application, it is expected that a TPE manufacturer will be able to offer not only one TPE compound with a specific hardness, but instead a whole series of compounds with different degrees of hardness. It is furthermore expected that as far as possible all compounds within this series have properties at an equally good, high level. To this market requirement, in addition to the above-mentioned opposing effects which influence the material properties, is added the further complicating issue of the production of such TPEs.

If there is a requirement profile, a person skilled in the art as a rule firstly selects a raw material or chooses a suitable TPE class that would best be able to achieve the required properties. Production parameters, such as the available production aggregate(s), the processability of the components and the product formed as well as possible upper limits on the production costs, often have a greatly restrictive effect on the raw material choice. Once a selection has been made, a person skilled in the art firstly optimizes the raw material proportions such that a property profile which is as optimal as possible and is necessary for satisfying the requirement profile results. After this optimization, the compilation of a series of TPE compounds with different hardnesses is then carried out for verification.

If a person skilled in the art chooses a TPV from the TPE class (in this specification, this should also include already-named mixtures of cross-linked elastomers and thermoplasts or TPEs), the same steps apply. In the case of TPEs which are present as a polymer blend (this also includes TPVs), the hardness is usually adjusted via the quantity of the thermoplast contained or generally of the thermoplastic phase and/or the quantity of process oil (also plasticizer) added. The thermoplastic phase can also be increased via the addition of TPE (for example TPC, TPU, TPA).

However, adjusting the hardness of the formulation optimized beforehand is generally accompanied by a deterioration of other required properties. Thus, for example, in order to achieve a higher hardness, more thermoplast has to be added or generally more thermoplastic phase has to be produced. This is, however, regularly accompanied by the deterioration of the elastic properties such as e.g. compression set, elongation at break and elasticity. A lower hardness can for example occur through addition of plasticizers or oils. However, elastomers have a limited capacity to absorb oils and start to leach oil out when too much oil is added. The mechanical properties and the chemical resistance are then often adversely affected thereby. The mechanical properties thus deteriorate on contact with non-polar media such as mineral oils, greases or fuels.

TPCs, TPAs and TPUs are TPEs which are composed of block copolymers. They exhibit high temperature resistance and/or good chemical resistance. However, these TPE classes principally stand for applications in the Shore D hardness range. Furthermore, they exhibit only moderate elastic properties and are significantly more expensive in comparison with TPSs, TPOs or TPVs. The spectrum of adjustable hardnesses in the case of these TPEs composed of block copolymers has, however, to date been limited, in a similar way to the TPEs composed of polymer blends described above. High hardnesses in the Shore A hardness range cannot be achieved without clear losses in terms of the fundamental elastic characteristics as, with an increasing proportion of thermoplast phase and associated decreasing proportion of elastomer, the thermoplastic properties become increasingly important.

In order to be able to provide the broadest possible spectrum of different hardnesses in the case of TPEs, it is necessary to find a way of being able to control these in a targeted manner without disrupting the fundamental product properties such as e.g. compression set and elasticity of these materials. It is also necessary for the durability of the resulting compositions to be sufficient in order not to experience any problems during the processing.

The object of the present invention is therefore to provide TPE compositions which have as far as possible consistently very good resetting properties, a good tension set, a good compression set, very good temperature resistance and chemical resistance in a broad hardness range of from 10 to 100 ShA (Shore A hardness). Furthermore, the object is to be able to produce not only individual TPE compositions, but also whole series of TPE compositions, which vary in hardness but otherwise have consistently high property levels. It should moreover be possible to process the TPEs by conventional processing techniques such as extrusion, injection moulding or blow moulding, i.e. the processing window, the period in which the compositions can be processed, must be sufficiently large.

The named object is achieved by a thermoplastic elastomer composition according to the invention which has a thermoplastic phase (T) and an elastomeric phase (EL), wherein T comprises at least one thermoplast (TP) from the class of the polyesters, polyamides or polyurethanes and at least one TPE from the TPC class (TPE based on copolyester), TPA (TPE based on polyamide) or TPU (TPE based on polyurethane), wherein EL comprises at least one cross-linked or uncross-linked elastomer, and wherein the weight ratio EL:T lies in the range of from 100:25 to 100:80, more preferably in the range of from 100:35 to 100:70 and most preferably in the range of from 100:40 to 100:60.

The EL:T weight ratio in the specified range represents an optimum compromise for the mechanical properties, temperature resistance, chemical resistance and processing behaviour.

A further alternative embodiment relates to a thermoplastic elastomer composition according to the invention as described above, in which the at least one thermoplast (TP) is a polyolefin and the at least one TPE is a TPO (TPE based on polyolefin). However, it is preferred according to the invention for the TP and the TPE to be selected from the classes named above.

In a further embodiment of the thermoplastic elastomer composition according to the invention, for reasons of better compatibility it is preferred for polyesters to be combined with TPCs and polyamides with TPAs or TPUs in the thermoplastic phase (T).

In a further embodiment, the thermoplastic elastomer composition according to the invention comprises a cross-linking agent, preferably for the cross-linking of the elastomeric phase (EL). Possible cross-linking agents are—depending on the use of the elastomer—those which are named below. In other words, the present invention is thus also intended to comprise cross-linked (vulcanized) thermoplastic elastomer compositions (TPV compounds) in which the at least one elastomer of the elastomeric phase is present cross-linked. For the cross-linking of the elastomer, a co-crosslinker can be used in addition to the cross-linking agent. Preferred co-crosslinkers are also named below.

In the thermoplastic elastomer composition according to the invention, the weight ratio of TP to TPE preferably lies in the range of from TP:TPE 5:95 to 95:5, more preferably in the range of from 10:90 to 80:20 and most preferably in the range of from 15:85 to 60:40.

If TPC is used as thermoplastic elastomer in the thermoplastic phase (T), this preferably has a Shore D hardness in the range of from 36 ShD to 60 ShD. If TPA or TPU is used as thermoplastic elastomer in the thermoplastic phase (T), this preferably has a Shore A hardness in the range of from 60 ShA to 90 ShA. The Shore hardness is a material characteristic value of an elastomer or plastic, the determination of which is specified in the standards DIN EN ISO 868 and DIN ISO 7619-1.

The thermoplastic elastomer composition according to the invention can also contain a plasticizer, a stabilizer, an auxiliary material, a dye, a filler and/or a compatibilizer. These are also described in more detail below. The plasticizer is here preferably used in a weight ratio of EL to plasticizer (phr) in the range of from 100:10 to 100:50, more preferably in a range of from 100:20 to 100:40 and most preferably in the range of from 100:25 to 100:35. The cross-linking agent is preferably used in a weight ratio of EL to cross-linking agent in the range of from 100:25 to 100:5, more preferably in the range of from 100:20 to 100:10 and most preferably in the range of from greater than or equal to 100:13 to 100:18. The co-crosslinker is preferably used in a weight ratio of EL to co-crosslinker in the range of from 100:1 to 100:10 and more preferably in the range of from 100:2 to 100:8. Stabilizers, auxiliary materials and dyes are preferably used in a weight ratio of EL to the named substances used in a range of from 100:5 to 100:20 and more preferably in a range of from 100:8 to 100:15. A filler is preferably used in a weight ratio of EL to filler in a range of from 100:1 to 100:10 and more preferably in a range of from 100:2 to 100:8.

If according to the invention a compatibilizer is used, this is preferably an elastomer as described below. In this case, the compatibilizer is to be regarded as a constituent of the elastomeric phase (EL) and is also to be taken into consideration correspondingly in all specified weight ratios. The weight ratio of the at least one elastomer to the elastomeric compatibilizer in the EL phase preferably lies in the range of from 99:1 to 80:20, more preferably in the range of from 95:5 to 85:15 and most preferably in the range of from 92:8 to 88:12.

Furthermore, the object of the present invention is achieved by being able to provide thermoplastic elastomer compositions which cover the broadest possible spectrum of different Shore hardnesses. Surprisingly it has been discovered that, when the weight ratio EL:T is kept constant but the weight ratio TP:TPE is varied, the Shore hardnesses of the thermoplastic elastomer compositions according to the invention can be varied in a broad range without properties such as compression set, tensile strength and elongation at break being significantly adversely affected thereby. In this way, thermoplastic elastomer compositions with Shore A hardnesses in the range of from 10 to 100 ShA, preferably 40 to 90 ShA can be realized.

The adjustment of the Shore hardness of a thermoplastic elastomer composition according to the invention thus takes place via the weight ratio of TP to TPE. A higher Shore hardness is achieved by a larger quantity of thermoplast. Lower Shore hardnesses are correspondingly achieved by a larger quantity of TPE. A small amount of thermoplast in relation to a large amount of TPE means a lower hardness. It has surprisingly been found that the TPE acts like a polymeric plasticizer in the thermoplastic phase (T).

The present invention thus also relates to a process for changing/adjusting the Shore hardness of thermoplastic elastomer compositions (preferably thermoplastic elastomer compositions according to the invention) without obtaining substantial deteriorations in the case of the compression set and/or the elongation at break and/or the tensile strength, wherein the thermoplastic elastomer compositions have a thermoplastic phase (T) and an elastomeric phase (EL), wherein T comprises a thermoplast (TP) and a thermoplastic elastomer (TPE), wherein, during the production of the thermoplastic elastomer compositions, the weight ratio EL:T is kept the same in comparison with a reference composition with predefined Shore hardness, but the weight ratio TP:TPE is varied, wherein the compression set of the thermoplastic elastomer compositions, measured after 24 hours at 120° C., is no more than 10 percentage points higher, and/or the elongation at break and/or the tensile strength of the thermoplastic elastomer compositions is no more than 10% lower, in each case in comparison with the reference composition.

A further advantage of the process according to the invention is that the processability of the material obtained does not substantially change during the variation of the weight ratio TP:TPE with weight ratio EL:T kept relatively constant.

In a further embodiment of the process according to the invention, it is preferred that, during the production of the thermoplastic elastomer compositions, the weight ratio TP:TPE is varied in comparison with the reference composition such that the quantity of TP or TPE is increased by at least 1 wt.-%, preferably at least 3 wt.-%, quite particularly preferably 5 wt.-%, and the quantity of the other in each case is lowered by the same percentage by weight.

In yet a further embodiment of the process according to the invention, it is preferred that the thermoplastic phase of the reference composition does not contain a thermoplast.

The optimization of the properties of a thermoplastic elastomer composition, such as compression set, elongation at break or tensile strength, thus preferably takes place in a first step. This first step comprises the choice of TPEs, thermoplasts and elastomers used and possibly of the cross-linking system as well as the corresponding quantity ratios. A composition is obtained which is used as reference composition within the meaning of the process according to the invention, before the hardness adjustment takes place in the compositions changed in relation thereto. Once the correct raw materials and the correct EL:T weight ratio for an optimum compression set, an optimum elongation at break and/or optimum tensile strength have been found, the Shore hardness of the composition is varied during a second step by changing the weight ratio of TP:TPE. In other words, the process according to the invention for changing/adjusting the Shore hardness of a thermoplastic composition is a screening process. In this way, the properties of thermoplastic elastomers according to the invention can be adjusted or changed in the desired manner. The process according to the invention provides further compositions with changed Shore hardness in addition to a reference composition. The requirements of an application or a field of application can thus optimally be met. Instead of only one optimized elastomer composition, a series with different degrees of hardness but properties at an equally high level can be offered on the market.

It is furthermore preferred that the compression set of the thermoplastic elastomer compositions, measured after 24 hours at 120° C., is no more than 5% higher, and/or the elongation at break and/or the tensile strength of the thermoplastic elastomer compositions is no more than 5% lower, and are more preferably at least the same, in each case in comparison with the reference composition. The compression set is quite particularly preferably smaller than in the case of the reference composition. The elongation at break and/or the tensile strength is furthermore preferably greater than in the case of the reference composition.

In the process according to the invention, it is preferred that the weight ratio EL:T lies in the range of from 100:25 to 100:80, more preferably in the range of from 100:35 to 100:70 and most preferably in the range of from 100:40 to 100:60.

It is furthermore preferred that the ratio TP:TPE is varied 5:95 to 95:5, more preferably in the range of from 10:90 to 80:20 and most preferably in the range of from 15:85 to 60:40.

A further subject of the present invention is a process for producing thermoplastic elastomer compositions (preferably thermoplastic elastomer compositions according to the invention), wherein an elastomeric phase (EL) and a thermoplastic phase (T), wherein T comprises at least one thermoplast (TP) and at least one thermoplastic elastomer (TPE), are blended at a temperature above the melting and softening point of TP and TPE, wherein the weight ratio EL:T lies in the range of from 100:25 to 100:80.

During the production according to the invention of the thermoplastic elastomer compositions, compositions which contain the elastomeric phase (EL) and the thermoplastic phase (T) are preferably subjected to a continuous mixing procedure at a temperature which lies above the highest melting and/or softening temperature of TP and TPE. Preferred temperatures above the melting and/or softening temperature of TP and TPE are named below. Various preferred variants of the production process according to the invention or of the components used therein are also named below.

The thermoplastic elastomer compositions according to the invention and the thermoplastic elastomer compositions changed or produced according to the invention are characterized by very high temperature and chemical resistance with simultaneously very good mechanical parameters in a very broad Shore A hardness range of from to 100 ShA.

The components named above and used in the thermoplastic elastomer compositions according to the invention or the processes according to the invention are abbreviated to the following letters and are described in more detail below:

A: elastomer
B: thermoplastic elastomer
C: thermoplast
D: plasticizer
E: cross-linking agent
F: co-crosslinker
G: stabilizer, auxiliary material, dye
H: filler
I: compatibilizer

### Component A: Elastomer

The elastomeric phase (EL) can comprise any elastomer known in the state of the art, which is compatible and thus miscible with the thermoplastic phase (T). The elastomer is preferably selected from the group which consists of styrene-butadiene rubber (SBR), styrene block copolymers (SBC), nitrile butadiene rubber (NBR), hydrogenated nitrile butadiene rubber (H-NBR), carboxylated nitrile butadiene rubber (X-NBR), ethylene-vinyl acetate copolymers (EVM), ethylene-propylene-diene rubber (EPDM), natural rubber (NR), butyl rubber (IIR), halobutyl rubber (halogenated IIR), isoprene rubber (IR), chloroprene rubber (CR), acrylate rubber (ACM), ethylene acrylate rubber (AEM), epichlorohydrin rubber (ECO), epoxidized natural rubber, silicone rubber and mixtures thereof.

Ethylene-vinyl acetate copolymers (EVM) are copolymers of an α-olefin, preferably ethylene, and vinyl acetate. EVMs are commercially available for example under the trade names Levapren® or Levamelt® from Lanxess Deutschland GmbH. α-Olefin copolymers preferably used according to the invention are the ethylene-vinyl acetate copolymers Levamelt® 400, Levamelt® 450, Levamelt® 452, Levamelt® 456, Levamelt® 500, Levamelt® 600, Levamelt® 700, Levamelt® 800 and Levamelt® 900 with 60±1.5 wt.-% vinyl acetate, 70±1.5 wt.-% vinyl acetate, 80±2 wt.-% vinyl acetate and 90±2 wt.-% vinyl acetate respectively, or respectively the corresponding types of Levapren®, with Levamelt® 600 being particularly preferred. In the compositions according to the invention, an α-olefin-vinyl acetate copolymer can be used as a component, however it is also possible to use mixtures of two or more α-olefin-vinyl acetate copolymers. The cross-linking in the case of EVMs takes place peroxidically.

Nitrile butadiene rubber (NBR) is a copolymer of acrylonitrile (ACN) and 1,3-butadiene. The nitrile proportion can be varied. Due to the double bonds that it contains, NBR can be cross-linked both peroxidically and by means of phenolic resins or sulphur. In the thermoplastic elastomer compositions according to the invention peroxidic cross-linking and cross-linking by means of phenolic resins are preferably used. Examples of NBR to be used according to the invention are known by the trade names Perbunan®, Krynac®, Buna® N, or Europrene® N and commercially available.

Hydrogenated nitrile butadiene rubber (H-NBR) is obtained by hydrogenation of the double bonds contained in NBR. H-NBR can be cross-linked peroxidically. Examples of H-NBR to be used according to the invention are known by the trade names THERBAN® (Lanxess) and THERBAN® AT (Lanxess) and commercially available.

So-called carboxylated nitrile butadiene rubber (X-NBR) is NBR which contains carboxylic acid groups at the double bonds of the butadiene. The carboxylic acid groups are randomly distributed over the polymer, and such a polymer preferably contains 10% carboxylic acid groups or less, relative to the possible number of carboxylatable carbon-carbon double bonds in the polymer. Due to the carboxyl groups contained in the polymer, the X-NBR can, in addition to peroxidic and phenolic resin cross-linking, also be cross-linked by means of metal ions which can be bonded coordinatively by the (deprotonated) carboxylic acid groups. An example of an X-NBR which can be used according to the invention is known by the trade name Krynac® X (Lanxess) and commercially available.

Styrene-butadiene rubber (SBR) is a copolymer of styrene and 1,3-butadiene, wherein according to the invention the styrene content is meant to be below 25% (in relation to the butadiene content), as the rubber takes on thermoplastic properties in the case of a higher styrene content. SBR can be cross-linked both peroxidically and by phenolic resins as well as by sulphur. In the compositions according to the invention peroxidic cross-linking and cross-linking by means of phenolic resins are preferably used here. Examples of SBR to be used according to the invention are known by the trade names KRALEX® SBR and Europrene® SBR and commercially available.

Styrene block copolymers (SBC) are copolymers of various polymer blocks, at least one block of which is a polystyrene block. More preferably, however, an SBC has the structure of a triblock copolymer in which the middle block is composed of a polymer different from polystyrene, wherein the two blocks at both ends each form a polystyrene block. As thermoplastic elastomers they represent a special case according to the invention. According to the invention the SBCs are divided into cross-linkable (SBC-Vs) and non-cross-linked SBCs.

An example of a non-cross-linked SBC is SEBS (styrene-ethylene-butylene-styrene). SEBS are triblock copolymers of 1,3-butadiene and styrene. The SEBS polymer is composed of three blocks, wherein the two end blocks are polymerized by polystyrene and the middle block is polymerized from butadiene. The polymer is then hydrogenated. A further example of an SBC, which can be used according to the invention and is not cross-linked, is SEPS (styrene-ethylene/propylene-styrene). Moreover, all further known SBCs which have been hydrogenated and thus contain no C—C double bonds are also to be named here as examples. If according to the invention hydrogenated SBCs (e.g. SEBS, hydrogenated SEPS, hydrogenated SEEPS etc.) are used in the elastomeric phase (EL), these are preferably intensively mixed with the thermoplastic phase (T) for the production of the thermoplastic elastomer compositions. Examples of hydrogenated SBCs to be used according to the invention are known by the trade names Kraton®, Septon®, Europrene® and Taipol® and commercially available.

SBC-Vs are SBCs which contain a cross-linkable group, such as for example SBS (styrene-butadiene-styrene), SIS (styrene-isoprene-styrene), SIBS (styrene-isoprene/butadiene-styrene), an SBC with α-methylstyrene block and an isoprene block, or a styrene block copolymer with (soft) vinyl polydiene block.

The SBC with α-methylstyrene block and an isoprene block is a triblock copolymer which is copolymerized from α-methylstyrene and isoprene. The two end blocks are polymerized from α-methylstyrene, wherein the middle block consists of polymerized isoprene monomers. The product with the trade name Septon® V (Kuraray) is such a polymer and can be cross-linked peroxidically, but according to the invention can also be used uncross-linked. According to the invention peroxidic cross-linking is preferably used here.

The styrene block copolymer with the soft vinyl polydiene block is a triblock copolymer which is copolymerized from styrene and predominantly vinyl-polymerized isoprene. The two end blocks are polymerized from styrene, wherein the middle block consists of polymerized isoprene monomers with a predominantly vinylic character. The product with the trade name Hybrar® (Kuraray) is such a polymer and can be cross-linked peroxidically as well as by phenolic resins or sulphur, but according to the invention can also be used uncross-linked. According to the invention peroxidic cross-linking and cross-linking by means of phenolic resins are preferably used here.

The SBS is a triblock copolymer which is copolymerized from styrene and 1,3-butadiene. The two end blocks are polymerized from styrene, wherein the middle block consists of polymerized 1,3-butadiene monomers. The product with the trade name Kraton® D (Kraton) is such a polymer and can be cross-linked peroxidically and with phenolic resins or sulphur, but according to the invention can also be used uncross-linked. According to the invention peroxidic cross-linking and cross-linking by means of phenolic resins are preferably used here.

If according to the invention ethylene acrylate rubber (AEM) is used as elastomer, the cross-linking can take place peroxidically, by means of metal ions or by means of diamine compounds. AEM is a copolymer of ethylene and methyl acrylate. It is commercially available for example as Vamac® from Du Pont.

Acrylate rubbers (ACM) are copolymers of acrylic acid alkyl ester and a further vinylic polymer, such as for example a copolymer of acrylic acid ester and 2-chloroethyl vinyl ether or a copolymer of acrylic acid ester and acrylonitrile. The nature of the cross-linking of such polymers is dependent on the comonomers used.

Natural rubber (NR) is a homopolymer of isoprene, which comprises almost exclusively 1,4-cis linking. Typically, the average molecular weight Mw is approximately 2*10⁶ g/mol. If according to the invention natural rubber is used as elastomer, it is preferably cross-linked peroxidically, phenolically or using sulphur.

Isoprene rubber (IR) is the synthetically produced variant of natural rubber. It differs from the latter primarily due to its somewhat lower chemical purity. This is due to the fact that the catalysts used for the polymerization have a lower effectiveness than the enzymes occurring in nature. The purity of natural rubber is preferably more than 99.9%, whereas in the case of synthetically produced IR—depending on the catalyst used—only approximately 92% to 97% is achieved. Like natural rubber, IR can also be cross-linked peroxidically, phenolically or with sulphur. The cross-linking preferably takes place phenolically or using peroxides.

Ethylene-propylene-diene rubber (EPDM) is a terpolymer, synthetic rubber. EPDM belongs to the random copolymers with saturated polymer framework. The production preferably takes place with metallocene or Ziegler-Natta catalysts based on vanadium compounds and aluminium alkyl chlorides. As diene, unconjugated dienes are used, only one double bond of which takes part in the polymer chain formation, with the result that further double bonds remain outside the direct chain framework and can be cross-linked with sulphur peroxidically or phenolically. As diene component, dicyclopentadiene (DCP), 1,4-hexadiene or ethylidenenorbornene (ENB, IUPAC: 5-ethylidene-2-norbornene) are used. The dienes differ with respect to the cross-linking speed. DCP has the lowest, ENB the highest reactivity.

Butyl rubber (IIR) is also named isobutene-isoprene rubber. It is a plastic from the group of elastomers and is one of the synthetic rubbers. It is a copolymer of isobutene and isoprene, wherein it preferably comprises isobutene in a quantity of from 95 to 99 mol.-% and isoprene in a quantity of 1-5 mol.-%, relative to its total molecular weight. It is preferably cross-linked according to the invention phenolically or using sulphur.

Halobutyl rubber (halogenated IIR) is butyl rubber which has preferably been halogenated with chlorine or bromine. For this, the rubber is preferably dissolved in an inert solvent and chlorine gas or liquid bromine is added under vigorous stirring. The resulting hydrogen halides are neutralized with sodium hydroxide solution.

Chloroprene rubber (CR) is also named polychloroprene or chlorobutadiene rubber and is a synthetic rubber which is also known by the brand name Neopren®. Neopren® is a brand name of the company DuPont, trade names of other manufacturers are e.g. Baypren® from Lanxess. Production takes place by polymerization of 2-chloro-1,3-butadiene (chloroprene).

Epichlorohydrin rubber (ECO) is produced by ring-opening polymerization of epichlorohydrin optionally in the presence of further comonomers. Epichlorohydrin rubber is commercially available for example under the trade name HydrinECO® from Zeon.

Silicone rubbers are produced from convertible materials in the rubbery-elastic state, which contain poly(organo)siloxanes and which comprise groups accessible for cross-linking reactions. In other words, silicone rubbers are poly(organo)siloxanes which are cross-linked with a cross-linking agent. The cross-linking can take place by means of (organic) peroxides; it can however also result in that Si—H groups are catalytically added to silicon-bound vinyl groups, wherein both groups are incorporated into the polymer chains or at their ends.

By “epoxidized natural rubber” is meant natural rubber as defined above, which has been epoxidized.

### Component B: Thermoplastic Elastomer (TPE):

As already mentioned above, the thermoplastic elastomer according to the invention is a TPC, TPA, TPO or TPU, wherein TPC and TPA are preferred according to the invention. Corresponding TPEs and the production thereof are known to a person skilled in the art.

Preferably, TPCs (TPEs based on copolyester) suitable according to the invention are generally copolyesters in the form of copolymers which comprise monomer units in the polymer main chain, which are linked via ester groups (—C(═O)—O—). Such thermoplastic copolyester elastomers can be produced by polycondensation. Such copolyesters are preferably multiblock copolyesters which generally comprise crystalline segments composed of hard blocks (X) and amorphous segments composed of soft blocks (Y). Suitable monomer components for constructing hard blocks (X) and soft blocks (Y) in multiblock copolyesters are known to a person skilled in the art. The copolyesters preferably used according to the invention have melting points or softening points in the range of from 160° C. to 300° C., preferably 165° C. to 270° C., particularly preferably 170° C. to 220° C. Preferred TPCs of the present invention are linear multiblock polyesters with a random distribution of high-melting, hard polyester blocks and low-melting, soft polyester blocks. The hard blocks form crystalline regions, the soft blocks form amorphous regions, which cause elastic behaviour at application temperatures of TPCs. The hard polyester blocks are preferably composed of short-chain dicarboxylic acids with fewer than 4 C atoms or aromatic dicarboxylic acids or mixtures of dicarboxylic acids. Preferred are aromatic dicarboxylic acids, particularly preferably isophthalic acid or terephthalic acid. The alcohol component is preferably also difunctional and consists of short-chain alkyl diols or short-chain polyoxyalkylene diols with fewer than 3 repeat units or mixtures of different diols. Preferred are short-chain diols such as ethylene glycol, 1,3-propanediol, 1,4-butanediol, 1,4-cyclohexanedimethanol, particularly preferred is 1,4-butanediol. The soft polyester blocks preferably consist of aliphatic or aromatic dicarboxylic acids, preferably of aromatic dicarboxylic acids, quite particularly preferably of isophthalic acid or terephthalic acid. In order to produce soft regions in the case of the TPCs, different types of diol are used; polyether diols such as polyethylene glycols, polypropylene glycols, polyethylene-co-propylene glycols, polytetramethylene glycols or soft polyester diols composed of alkane dicarboxylic acids, for example adipic acid or sebacic acid, and alkane diols, or polycaprolactone diols or aliphatic polycarbonate diols. However, mixtures of diols can also be used. Preferred are hard TPC regions, composed of terephthalic acid and short-chain diols, particularly preferably 1,4-butanediol, combined with soft regions, preferably composed of terephthalic acid and polyether diols, quite particularly preferably of polytetramethylene glycol. The copolyesters suitable as component B in the compositions according to the invention can be produced according to processes known to a person skilled in the art or are commercially available. Suitable commercially available copolyesters are e.g. TICONA—Riteflex®, P.GROUP—PIBIFLEX®, DSM—Arnitel®, Kolon—KOPEL-PEL®, PTS—Uniflex@, Ria-Polymers—Riaflex®, LG Chem.—KEYFLEX®, and DuPont—Hytrel®.

TPAs of the present invention are characterized in that they have polyamides as hard, crystalline segments. The soft, amorphous regions consist of polyethers and/or polyesters. A distinction is made between polyester amides, polyether ester amides, polycarbonate ester amides and polyether block amides. Polyester amides, polyether ester amides and polycarbonate ester amides are formed by reaction of aromatic diisocyanates with aliphatic dicarboxylic acids, which form the polyamide blocks, and carboxyl-terminated aliphatic polyesters (resulting in polyester amides), carboxyl-terminated aliphatic polyester ethers (resulting in polyether ester amides) and carboxyl-terminated polycarbonate diols (resulting in polycarbonate ester amides). Polyether block amides are formed by reaction of carboxyl-terminated polyamides and hydroxy-terminated polyether diols. Preferred as TPAs are polyether block amides, particularly preferably those with polytetramethylene glycol as soft segment. Suitable commercially available TPAs are Arkema—Pebax®, DK Kunststoffservice GmbH Multiflex®, and EVONIK Industries/Degussa—VESTAMID® E.

Of the polymers described in Chapter 5 of “G. Holden, H. R. Kricheldorf, R. P. Quirk (Eds.), Thermoplastic Elastomers, Carl Hanser Verlag, 3rd Ed., Munich (2004)”, the block copolymers are preferably intended to be considered as TPOs according to the invention (Chap. 5.3). TPOs composed of block copolymers of PP and PE may be particularly preferred for the application described here.

Preferred TPUs within the meaning of the present invention are thermoplastic elastomers based on polyurethane, such as e.g. the Desmopan®, Texin® and Utechllan® types available from Bayer.

### Component C: Thermoplast (TP):

The thermoplasts suitable according to the invention as component C are preferably miscible with the TPE in the thermoplastic phase (T) in any ratio. Particularly preferred are thermoplasts the chemical composition of which corresponds to the chemical composition of one of the blocks of the TPE used.

As already stated above, the thermoplast is a polyester, polyamide or polyurethane.

When a polyester is used as thermoplast, it should be ensured that only polyesters which actually have thermoplastic properties are used. Here, polyesters which have no thermoplastic properties, in particular polyesters which are used as plasticizers, or polyester resins, should explicitly be excluded according to the invention. Preferably, polyesters which have an average molecular weight of >10,000 g/mol are used according to the invention. The same also applies when polyamides or polyurethanes are used as thermoplasts. It is furthermore preferred to use polyesters which comprise aromatic units in the polymer main chain.

Examples of polyesters which can be used according to the invention are polyalkylene terephthalates or polyalkylene phthalates, with greater preference being given to polyalkylene terephthalates. Particularly preferably, the polybutylene terephthalate (PBT) which corresponds to the hard segment in the TPC may be named here and is therefore for example preferably used with the latter in the thermoplastic phase (T).

Thus, for example, polyamides (PA) are also particularly suitable when TPA (carries PA12 in the hard segments) is used in the thermoplastic phase (T).

When TPU is used as component B the urethane segments are similar to those of the amide group, with the result that PA and TPU can be mixed and can also be used together in the thermoplastic phase (T). Furthermore, with TPU as component B, according to the invention polycarbonates (PC), as well as acrylonitrile-butadiene-styrene (ABS), are also suitable as component C.

Polyalkylene terephthalates are preferably produced by polycondensation of terephthalic acid and alkyl diol. 1,4-Butanediol is particularly preferably used as alkyl diol, with the result that polybutylene terephthalate (PBT) forms. The polyalkylene terephthalates preferably used according to the invention have melting points or softening points in the range of from 160° C. to 300° C., preferably 175° C. to 270° C., particularly preferably 200° C. to 230° C. Known trade names and the manufacturers thereof are: Arnite® (DSM), Celanex® (Ticona), Crastin® (DuPont), DYLOX® (Hoffmann+Voss GmbH), Later® (LATI), Pocan® (Lanxess), Schuladur® (A. Schulman), Ultradur® (BASF), Valox® (Sabic Innovative Plastics) and VESTODUR® (Evonik Industries AG).

Polyamides (PA) are condensation products of amino carboxylic acids, lactams and/or dicarboxylic acids and diamines. The PAs used according to the invention belong to the broad spectrum of different polyamides (PA6 PA6.6 PA12 etc.) known to a person skilled in the art. The PAs preferably used according to the invention have melting points or softening points in the range of from 160° C. to 300° C., preferably 165° C. to 270° C., particularly preferably 180° C. to 230° C. Known trade names and the manufacturers thereof are: Akulon (DSM), Durethan (Lanxess), Frianyl (NILIT Plastics Europe, formerly Frisetta Polymer), Akromid (Akroloy), Schulamid (A. Schulman), Technyl (Rhodia), Torzen (Invista), Ultramid, Miramid (BASF), UNYLON (UNYLON Polymers), Vestamid (Evonik Industries) and Zytel (DuPont).

### Component D: Plasticizer:

Suitable plasticizers are in principle known to a person skilled in the art. Suitable plasticizers for polar elastomers (EVM, NBR, H-NBR X-NBR, AEM, ACM etc.) are e.g. ester plasticizers such as phthalic acid esters, for example dioctyl phthalate, diisooctyl phthalate, dinonyl phthalate or diisodecyl phthalate; aliphatic esters such as dioctyl acid ester or dioctyl sebacic acid ester; phosphoric acid esters such as tricresyl phosphoric acid ester, diphenyl cresylic acid ester or trioctyl phosphate; polyesters such as polyphthalic acid ester, polyadipic acid ester or polyester ether.

Suitable plasticizers for non-polar elastomers (SBR, EPDM, SBC etc.) are technical or medical mineral or white oils, native oils such as for example soya or rapeseed oil, alkylsulphonic ester, in particular alkylsulphonic phenyl ester, wherein the alkyl substituents contain linear and/or branched alkyl chains with >5 C atoms. Furthermore, di- or trialkyl esters of mellitic acid, wherein the alkyl substituents preferably contain linear and/or branched alkyl chains with >4 C atoms. Furthermore, alkyl esters of di-, tri- and higher polycarboxylic acids, wherein the alkyl substituents are preferably linear and/or branched alkyl chains, are also used as corresponding plasticizers. Adipic acid di-2-ethylhexyl ester and tributyl 0-acetylcitrate may be named as examples. Furthermore, carboxylic acid esters of mono- and/or polyalkylene glycols can also be used as plasticizers, such as for example ethylene glycol adipate. Mixtures of the substance classes described can also be used as suitable plasticizers.

### Component E: Cross-Linking Agent:

Depending on the elastomer used, it is known to a person skilled in the art, which cross-linking agent can be taken in order to achieve a cross-linking. According to the invention the elastomers named above can be cross-linked either by the addition of peroxides, phenolic resins, sulphur or metal ions.

Peroxides suitable as radical cross-linking initiators (cross-linking agents) are known to a person skilled in the art. Examples thereof are organic peroxides, e.g. alkyl and aryl peroxides, alkyl peracid esters, aryl peracid esters, diacyl peroxides, polyvalent peroxides such as 2,5-dimethyl-2,5-di(tert-butylperoxy)hexyne-3 (e.g. Trigonox® 145-E85 or Trigonox® 145-45B), di-tert-butyl peroxide (e.g. Trigonox® B), 2,5-dimethyl-2,5-di(tert-butylperoxy)hexyne (e.g. Trigonox® 101), tert-butyl cumyl peroxide (e.g. Trigonox® T), di(tert-butylperoxyisopropyl)benzene (e.g. Perkadox® 14-40), dicumyl peroxide (e.g. Perkadox® BC 40), benzoyl peroxide, 2,2′-bis(tert-butylperoxy)diisopropylbenzene (e.g. Vulcup®40 AE), 3,2,5-trimethyl-2,5-di(benzoylperoxy)hexane and (2,5-bis(tert-butylperoxy)-2,5-dimethylhexane, 3,3,5,7,7-pentamethyl-1,2,4-trioxepane (e.g. Trigonox® 311).

Peroxides the cross-linking temperatures of which lie above the melting or softening temperatures of component A are preferably used. Because of the high melting or softening temperature of the thermoplastic phase used according to the invention as components B and C, according to the invention the cross-linking of the elastomeric phase for producing the thermoplastic elastomer compositions preferably takes place in a correspondingly hot melt. This requires—in a preferred embodiment—the use of peroxides with high cross-linking temperatures. Peroxides with lower (usual) cross-linking temperatures already degrade on first contact with the polymer melt and are not mixed in homogeneously and cross-link the elastomeric phase insufficiently or inhomogeneously. Therefore peroxides are particularly preferably used according to the invention, which have cross-linking temperatures of 175° C., particularly preferably ≥180° C., quite particularly preferably ≥185° C., especially quite particularly preferably ≥190° C. and further quite particularly preferably ≥200° C.

When a peroxide is used as cross-linking agent it is furthermore preferred according to the invention that the (still cross-linkable) thermoplastic elastomer compositions comprise the peroxide in a quantity of from 0.2 to 10 parts by weight per 100 parts by weight of the elastomeric phase (EL) (phr), preferably 0.5 to 8 phr, particularly preferably 1 to 6 phr.

In particular when diene-containing rubbers, such as e.g. SBR or NBR as well as H-NBR or EPDM, are used as component A, in addition to peroxidic cross-linking phenolic resins are also suitable for cross-linking component A. Here phenolic resins with sufficiently high reactivity at mixing temperatures of at least 220° C. are preferably used. Brominated phenolic resins are also to be named here.

To accelerate the phenolic resin cross-linking inorganic compounds known to a person skilled in the art are used. For example SnCl₂ and/or ZnO and/or ZnCl₂ can be used for acceleration and catalysis of the reaction. However, halogen-containing elastomers can also be used. ZnO is particularly preferably used as it also acts as catalyst.

In the case of non-brominated phenolic resins, it is also useful to add halogen donors in the form of Lewis acids or chloroprene rubber. Thus in the thermoplastic elastomer compositions according to the present invention a combination of at least one phenolic resin and at least one Cl-containing Lewis acid, preferably SnCl₂, can be used as cross-linking agent. ZnCl₂ or SnCl₂ is preferably used as Cl-containing Lewis acid, wherein it is preferred that ZnO is additionally used when SnCl₂ is used. As an alternative to the named Lewis acids a mixture of chloroprene rubber and ZnO can also be used. In the case of the use of brominated phenolic resins the use of a Lewis acid is preferably not necessary; however ZnO is then preferably additionally used. Phenolic resins suitable for this purpose are known to a person skilled in the art and are usually obtained by reaction of phenols with aldehydes (phenol-formaldehyde resin). Phenolic resins suitable for this purpose are e.g. the products of the reaction of octylphenol with formaldehyde, e.g. SP-1045 H (SP-1045, HRJ-10518 H from Schenectady International Inc.), which is an octylphenol-formaldehyde resin that contains methylol groups, is suitable, or in the case of brominated phenolic resins, brominated octylphenol resins, for example those with the trade names SP-1055 and SP-1056. Suitable Cl-containing Lewis acids are known to a person skilled in the art. SnCl₂ or chloroprene rubber is preferably used.

When the combination of at least one phenolic resin with at least one Cl-containing Lewis acid, preferably SnCl₂, is used, the at least one phenolic resin is preferably used in a quantity of from 2 to 5 parts by weight, relative to the total quantity of the thermoplastic elastomer composition, and the Cl-containing Lewis acid is preferably used in a quantity of from 0.2 to 0.7 parts by weight, relative to the total quantity of the thermoplastic elastomer composition.

Cross-linking using sulphur is one of the oldest possibilities for cross-linking rubbers, which is known to a person skilled in the art in this field.

### Component F: Co-Crosslinker:

In a preferred embodiment according to the invention, the thermoplastic elastomer compositions additionally contain at least one co-crosslinker as component F. The co-crosslinker is used in a weight ratio of elastomer to co-crosslinker in the range of from 100:10 to 100:2 and more preferably in the range of from 100:8 to 100:3.

Suitable co-crosslinkers for peroxides as cross-linking agents are for example selected from the group consisting of triallyl isocyanurate (TAIC) (e.g. DIAK7™ from DuPont), trimethylolpropane trimethacrylate (TRIM) (e.g. Rhenogran TRIM® S from Rheinchemie), N,N′-m-phenylene dimaleimide (e.g. HVA-2® from DuPont Dow), triallyl cyanurate (TAC), liquid polybutadiene (e.g. Ricon® D153 from Ricon Resins), p-quinodixon, p,p′-dibenzoyl quinodioxin, N-methyl-N,N-dinitrosoaniline, nitrobenzene, diphenylguanidine, trimethylolpropane-N,N′-m-phenylene maleimide, N-methyl-N,N′-m-phenylene dimaleimide, divinylbenzene, polyfunctional methacrylate monomers such as ethylene glycol dimethacrylate, diethylene glycol dimethacrylate, polyethylene glycol dimethacrylate, trimethylolpropane trimethacrylate and allyl methacrylate, and polyfunctional vinyl monomers such as vinyl butyrate and vinyl stearate. Preferably used co-crosslinkers are selected from the group consisting of trimethylolpropane trimethacrylate (TRIM), triallyl isocyanurate (TAIC), N,N′-m-phenylene dimaleimide, triallyl cyanurate (TAC) and liquid polybutadiene. Trimethylolpropane trimethacrylate (TRIM) is particularly preferably used as co-crosslinker. It is possible, in the cross-linkable compositions according to the invention, to use one co-crosslinker or two or more co-crosslinkers together.

### Components G to I:

Suitable components G to I are in principle known to a person skilled in the art. Examples of suitable fillers, stabilizers, auxiliary materials, dyes and compatibilizers are named below:

### Component H: Fillers:

Suitable fillers are e.g. soot, chalk (calcium carbonate), kaolin, siliceous earth, talcum (magnesium silicate), aluminium oxide hydrate, aluminium silicate, calcium carbonate, magnesium carbonate, calcium silicate, magnesium silicate, barium sulphate, zinc carbonate, calcined kaolin (e.g. Polestar® 200 P), calcium oxide, magnesium oxide, titanium oxide, aluminium oxide, zinc oxide, silanized kaolins, silanized silicate, coated chalk, treated kaolins, fumed silica, hydrophobic fumed silica (e.g. Aerosil® 972), synthetic, amorphous precipitated silica (silica), carbon black, graphite, nanoscale fillers such as carbon nanofibrils, nanoparticles in platelet form or nanoscale silicon dioxide hydrates and minerals.

### Component G: Stabilizers, Auxiliary Materials and Dyes (Additives):

Suitable additives are e.g. processing auxiliary materials, metal soaps, fatty acids and fatty acid derivatives, factice ([made-up word]: rubber-like substance which is obtained e.g. by the action of sulphur or sulphur chloride on drying oils; serves for stretching rubber), anti-ageing agents, anti-UV agents or antiozonants such as antiozonant waxes, antioxidants, e.g. polycarbodiimides (e.g. Rhenogran® PCD-50), substituted phenols, substituted bisphenols, dihydroquinolines, diphenylamines, phenylnaphthylamines, paraphenylenediamines, benzimidazoles, paraffin waxes, microcrystalline waxes, pigments, dyes such as titanium dioxide, lithopone, zinc oxide, iron oxide, ultramarine blue, chromium oxide, antimony sulphide; stabilizers such as heat stabilizers, stabilizers against weathering; antioxidants, e.g. p-dicumyldiphenylamine (e.g. Naugard® 445), styrenated diphenylamine (e.g. Vulcanox® DDA), zinc salt of methyl mercaptobenzimidazole (e.g. Vulcanox® ZMB2), polymerized 1,2-dihydro-2,2,4-trimethylquinoline (e.g. Vulcanox® HS), thiodiethylene bis(3,5-di-tert-butyl-4-hydroxy)hydrocinnamate, thiodiethylene bis[3-(3,5-di-tert-butyl-4-hydroxyphenyl)propionate] (e.g. Irganox® 1035), lubricants, release agents, flame retardants (fire protection agents), adhesion promoters, tracers, minerals as well as crystallization accelerators and retarders.

Processing auxiliary materials, stabilizers or fillers can be added as further additives. Process oils can be added if required, but preferably <5 wt.-%, preferably <2 wt.-%. According to a further embodiment of the invention no process oils are added.

The following may be named as processing auxiliary materials and stabilizers: antistatics, anti-foaming agents, lubricants, dispersants, release agents, anti-blocking agents, free-radical scavengers, antioxidants, biocides, fungicides, UV stabilizers, other light stabilizers, metal deactivators, in addition also additives such as foaming aids, propellants, fire protection agents, flue gas suppressors, impact resistance modifiers, adhesive agents, anti-fogging agents, dyes, colour pigments, colour masterbatches, viscosity modifiers. Fillers which may be mentioned are for example kaolin, mica, calcium sulphate, calcium carbonate, silicates, silica, talcum, soot, graphite or synthetic fibres.

### Component I: Compatibilizer:

The compositions according to the invention or compositions produced according to the invention can also contain at least one compatibilizer, preferably in order to bond the thermoplastic phase (T) to the elastomeric phase (EL).

Compatibilizers are in principle known to a person skilled in the art. For example functionalized polyolefins or polyolefin copolymers are suitable as compatibilizers. Suitable functional groups of the functionalized polyolefins or polyolefin copolymers are carboxyl groups, carbonyl groups, halogen atoms, amino groups, hydroxy groups or oxazoline groups. The polyolefins or polyolefin copolymers are preferably functionalized with carboxyl groups. Production processes for suitable polyolefins functionalized with carboxyl groups are for example disclosed in DE 41 23 963 A1 and the literature cited therein.

The compatibilizer in the compositions according to the present invention is preferably a copolymer based on the corresponding component A according to the invention, here using the example of EVM as component A, α-olefin-vinyl acetate copolymer as polymer backbone, which is functionalized with carboxyl groups, carbonyl groups, halogen atoms, amino groups, hydroxy groups or oxazoline groups, preferably with carboxyl groups. A compatibilizer is particularly preferably used in the compositions according to the present invention, which is obtained by means of grafting of α,β-ethylenically unsaturated mono- and/or dicarboxylic acids or derivatives thereof onto an α-olefin-vinyl acetate copolymer backbone. Suitable processes for producing the particularly preferred compatibilizer are known to a person skilled in the art and named for example in EP 1 801 162 A1.

Production of the compositions according to the invention and cross-linking or mixing to form thermoplastic elastomer compositions:

The thermoplastic elastomer compositions according to the present invention can be produced by mixing components A, B, C, D, E, F, G, H and I—insofar as they are present in the compositions. Mixing can take place using mixing systems known in rubber technology and plastic technology such as internal mixers, e.g. internal mixers with intermeshing or tangential rotor geometry, as well as also in continuous mixing equipment such as mixing extruders, e.g. mixing extruders with 2 to 4 or more shaft screws.

When carrying out the production process according to the invention it is important to ensure that the mixing temperature is sufficiently high that components B and C can be transformed into the plastic state, but are not damaged in the process. This is guaranteed if a temperature above the highest melting or softening temperature of components B and C is selected. The components—insofar as they are present in the compositions—are particularly preferably mixed at a temperature in the range of from 150° C. to 350° C., preferably 150° C. to 280° C., particularly preferably 170° C. to 240° C.

Different variants are in principle possible for mixing the individual components.

Variant 1: A, B, C, D, E, F, G, H and I—insofar as they are contained in the composition according to the invention—are combined and intimately mixed at temperatures above the highest melting or softening temperatures of components B and C.

Variant 2: A, B, C, D, G, H and I—insofar as they are contained in the composition according to the invention—are combined and intimately mixed at temperatures above the highest melting or softening temperatures of components B and C. Components E and F (insofar as they are present in the formulation according to the invention) are then added and further mixed on arriving at the temperature reached.

Variant 3: A, D, E, F, G, H, and I—insofar as they are contained in the composition according to the invention—are combined and intimately mixed until below the reaction temperature of E. Components B and C (insofar as they are contained in the formulation according to the invention) are then added and heated to the softening temperature of B and C with continuous mixing. The addition temperature of B and C (insofar as they are contained in the formulation according to the invention) can take place above or below the softening temperature of B and C (insofar as they are contained in the formulation according to the invention).

Variant 4: B, C and H—insofar as they are contained in the composition according to the invention—are combined and intimately mixed at temperatures above the highest melting or softening temperatures of components B and C. Components A, D, E, F, G and I (insofar as they are contained in the formulation according to the invention) are added and further intimately mixed the temperature above the highest melting or softening temperatures of components B and C.

Variant 1 is particularly preferred for production in an internal mixer. Variant 3 is particularly preferred for production in continuous mixing equipment.

By means of the above-named process variants, in particular by means of process variants 1 and 3, it is achieved that component A and components B and C have undergone the finest and most homogeneous distribution possible after completion of production. A particle size of the elastomer particles (insofar as they are contained in the formulation according to the invention) before the cross-linking of <5 μm is typical.

The temperature, mentioned above and below, above the highest melting or softening temperature of components B and C is dependent on the components B and C used. The temperature above the highest melting or softening temperature of components B and C is preferably 150° C. to 350° C., particularly preferably 170° C. to 240° C.

The addition time, temperature, form and quantity of components E and F should in addition be selected such that a good distribution of components E and optionally F in the elastomer phase is guaranteed, the elastomer and thermoplast phases (B,C) are present in the state described above and only then does the cross-linking of the elastomer phase take place (if cross-linking does take place, exceptions are non-cross-linkable SBCs, see above), with the result that a phase reversal takes place or a co-continuous phase structure of the elastomeric phase and the thermoplastic phase takes place (in particular when styrene-butadiene polymers are used as component A, or the elastomer is present dispersed in the thermoplastic phase with particles <5 μm.

The compositions according to the invention are outstandingly suitable for providing thermoplastic elastomers with balanced properties, in particular with very good temperature and chemical resistance with simultaneously very good elastic properties (compression set, elongation at break and tensile strength) in a broad hardness range.

In addition, the use of the combination of components B and C opens up the possibility of adjusting the hardness of one of the formulations according to the invention cost-effectively, as usually the component B used is more expensive than the component C used according to the invention. Furthermore, it has surprisingly emerged that the temperature performance of the formulation according to the invention can be shifted to higher temperatures through a suitable choice of component C, as can be confirmed by DSC (differential scanning calorimetry) measurements.

According to the present invention it is preferred that the elastomeric phase (EL) is cross-linked during or after blending with the thermoplastic phase (T), i.e. the cross-linking takes place dynamically. The cross-linking of the preferably dispersed elastomeric phase (EL) preferably takes place during the mixing of components A to I (insofar as these are present in the mixture). The cross-linking preferably starts when the blending is continued at a temperature above the melting or softening temperature of components B and C in the presence of components E and optionally F over a period of at least 15 sec.

After phase reversal or formation of a co-continuous phase has taken place, the product obtained, i.e. the thermoplastic elastomer composition, is cooled down preferably to a temperature below the melting or softening temperature of component B and/or C.

A further subject of the present invention is thermoplastic elastomer compositions which can be obtained by the processes according to the invention.

The thermoplastic elastomer compositions according to the invention or produced according to the invention are characterized according to the present invention by the fact that the elastomer component A is present in finely distributed form or (in the case of SBCs) in the finely dispersed co-continuous network in the thermoplastic phase (T). The obtained thermoplastic elastomer compositions according to the present invention are characterized by a very good temperature and media resistance with simultaneously very good elastic properties (tensile strength, elongation at break and compression set) in a broad hardness range. They also have excellent physical and dynamic properties, for example an excellent compression set, at high temperatures, which are above all required in automobile manufacture. Only after melting the thermoplastic phase (T) can the entire system be processed thermoplastically and thus meets the necessary requirements for a thermoplastic elastomer.

A further subject of the present invention is thus the use of the thermoplastic elastomer compositions according to the invention or produced according to the invention for the production of shaped parts from a thermoplastic elastomer, for example belts, seals, sleeves, hoses, membranes, dampers, profiles, or cable sheathing, hot-melt adhesives, films or for plastic-rubber co-extrusion, or for shaped part co-injection moulding.

The present invention also relates to shaped parts, such as cable sheathing, hot-melt adhesives or films, which contain the thermoplastic elastomer compositions according to the invention.

The shaped parts according to the invention are characterized by excellent physical properties, in particular excellent elasticities in a broad hardness range, as well as high-temperature resistance and media resistance, in particular oil resistance. These properties are highly significant in particular for hoses, belts, membranes, seals, bellows, cable sheathing, hot-melt adhesives, films as well as sleeves for example for automobile and other industrial applications. The shaped parts can be produced e.g. in a simple manner in a one-step process.

The terms “comprise”, “contain” and “have” used in the present application are meant in each case where they are used to also cover the term “consist of”, with the result that these embodiments are also disclosed in this application.

The present invention will now be explained in more detail through the following embodiment examples. The following embodiment examples are only exemplary in nature and do not serve to limit the present invention thereto.

### EXAMPLES

### Methods of Determination and Definitions

Determination of the Shore hardness takes place according to DIN EN ISO 868 and DIN ISO 7619-1.

By “tensile strength” is meant the maximum mechanical tensile stress which a material withstands before it breaks/tears. In the tensile test it is calculated from the maximum tensile force achieved relative to the original cross section of the (standardized) sample and indicated in N/mm².

The elongation at break is a material characteristic which indicates the remaining elongation of the break, relative to the initial measurement length. The elongation at break is one of many parameters during material testing and characterizes the deformation capability of a material. It is the remaining change in length ΔL relative to the initial measurement length L₀ of a sample in the tensile test after breaking. This change in length is indicated in %.

The compression set is a measure of how (thermoplastic) elastomers behave in the case of long-lasting, constant compression and subsequent decompression. According to DIN ISO 815 the compression set (CS) is measured at constant strain. This represents the deformation component of the test material. Many test methods for elastomers, such as e.g. the tensile strength, characterize the quality and nature of the material. On the other hand, the CS is an important factor which has to be taken into account before use of a material for a specific purpose. Permanent deformation, the compression set (CS) is an important parameter particularly for the use of seals and shims made of elastomers. In order to determine this quantity a cylindrical test piece is compressed by e.g. 25% and stored thus for a certain time at a specific temperature. The temperature and the medium (usually air, but also oils and other industrial fluids) for the compression test depend on the material to be tested, its intended purpose and the test setup (e.g. 24 h at 150° C.). 30 minutes after decompression the height is again measured at room temperature and the permanent deformation ascertained therefrom. A compression set of 0% means that the test piece has again completely reached its original thickness, a CS of 100% indicates that the test piece has been completely deformed during the test and shows no resetting. The calculation is carried out according to the following formula: CS (%)=(L₀−L₂)/(L₀−L₁)×100%, wherein:

CS=compression set in %
L₀=height of the test piece before testing
L₁=height of the test piece during testing (spacer)
L₂=height of the test piece after testing.

### EMBODIMENT EXAMPLES

Table 1 indicates the abbreviations used for the components used in the examples:

TABLE 1

| Component | Raw material |
|---|---|
| A | Elastomer (rubber) |
| B | Thermoplastic elastomer |
| C | Thermoplast |
| D | Plasticizer |
| E | Cross-linking agent (for example |
| | peroxide (batch) or phenolic |
| | resin) |
| F | Co-crosslinker |
| G | Stabilizer, auxiliary material and |
| | dye |
| H | Filler |
| I | Compatibilizer |

### Example 1: Production of a Reference Composition of a Thermoplastic Elastomer

According to the above-named production variant 3, a thermoplastic elastomer composition is produced with the constituents shown in Tables 2 and 3. A twin-screw extruder is used for blending the components used.

### Example 2: Production of a Further Comparison Composition of a Thermoplastic Elastomer not According to the Invention

This composition is produced in the same way as in Example 1, with the difference that not TPC1, but TPC2 is used as component B.

### Example 3: Production of a Composition of a Thermoplastic Elastomer According to the Invention

The composition in Example 3 is produced in the same way as in Example 1, with the difference that TPC1 was used as component B in a lower quantity indicated in Table 2 and additionally polybutylene terephthalate was used as component C in the quantity indicated in Table 2.

### Example 4: Production of a Further Comparison Composition of a Thermoplastic Elastomer not According to the Invention

The composition in Example 4 was produced in the same way as in Example 1, with the difference that not TPC1, but TPC3 was used as component B, and the plasticizer was omitted.

### Example 5: Production of a Composition of a Thermoplastic Elastomer According to the Invention

The composition in Example 5 was produced in the same way as in Example 1, with the difference that TPC1 was used as component B in a lower quantity indicated in Table 2 and additionally polybutylene terephthalate was used as component C in the quantity indicated in Table 2.

### Observations:

As can be seen from the comparison of the compositions from Examples 3 and 5 according to the invention in comparison with the comparison composition from Example 1 in Table 4, neither the tensile strength, nor the elongation at break, nor the compression set changes to a significant extent when component B (TPE) is replaced by component C (TP). Yet the hardness can be increased from 60 ShA (Example 1) to 70 ShA (Example 3) and 80 ShA (Example 5).

As can be seen by comparison of the compositions according to Examples 1 and 2, although the hardness can also be increased to a certain extent by replacing component B by another component B, this is however at the expense of the maximum throughput during production (see Table 5) and of the raw material input (see Table 7). The same also applies when a plasticizer is omitted (see composition Example 4).

The maximum possible lifetime in the injection moulding machine is also just as good in the case of the compositions according to the invention as in the case of the base composition in Example 1, and significantly better than in the case of the compositions of Examples 2 and 4.

### Example 6: Production of a Comparison Composition of a Thermoplastic Elastomer not According to the Invention

According to the above-named production variant 3, a thermoplastic elastomer composition is produced with the constituents shown in Tables 8 and 10. A twin-screw extruder is used for blending the components used.

### Example 7: Production of a Further Comparison Composition of a Thermoplastic Elastomer not According to the Invention

This composition is produced in the same way as in Example 6, with the differences in the composition indicated in Table 8.

### Example 8: Production of a Composition of a Thermoplastic Elastomer According to the Invention

The composition in Example 8 is produced in the same way as in Example 6, with the difference that not only was the TPA used as component B in a quantity indicated in Table 8, but additionally AQUAMID® 6AF was also used as component C in the quantity indicated in Table 8.

### Example 9: Production of a Further Composition of a Thermoplastic Elastomer According to the Invention

The composition in Example 9 is produced in the same way as in Example 6, with the main difference that not only was the TPA used as component B in a quantity indicated in Table 8, but additionally AQUAMID® 6AF was also used as component C in the quantity indicated in Table 8.

### Example 10: Production of a Composition of a Thermoplastic Elastomer According to the Invention

The composition in Example 10 is produced in the same way as in Example 6, with the main difference that not only was the TPA used as component B in a quantity indicated in Table 8, but additionally AQUAMID® 6AF was also used as component C in the quantity indicated in Table 8.

### Example 11: Production of a Further Comparison Composition of a Thermoplastic Elastomer not According to the Invention

This composition is produced in the same way as in Example 6, with the differences in the composition indicated in Table 9.

### Example 12: Production of a Further Comparison Composition of a Thermoplastic Elastomer not According to the Invention

This composition is produced in the same way as in Example 6, with the differences in the composition indicated in Table 8.

### Observations:

As can be seen from the comparison of the compositions from Examples 8 to 10 according to the invention in comparison with the comparison compositions from Examples 6 and 7 in Table 10, neither the tensile strength, nor the elongation at break, nor the compression set changes to a significant extent through the addition of component C (TPA). However, the hardness can be varied to a certain extent. It can furthermore be seen in Examples 11 and 12 not according to the invention (Table 9) that the hardness of the resulting composition can also be increased with the “harder” TPA Pebax® 7033 (Table 12). However, the elongation at break and the compression set are significantly worse here. Thus not only can the hardness be increased through the addition of a polyamide in the composition, but the good mechanical properties of the material are also retained. Table 13 shows the change in the tensile strength and the elongation at break of the compositions after treatment in diesel at 60° C. for 21 days.

TABLE 2
Compositions

| | | Example 1 | Example 2 | Example 3 | Example 4 | Example 5 |
|---|---|---|---|---|---|---|
| Raw material | Component | phr | phr | phr | phr | phr |
| EVM | A | 90 | 90 | 90 | 90 | 90 |
| TPC1 | B | 58 | | 34 | | 15 |
| TPC2 | | | 60 | | | |
| TPC3 | | | | | 51 | |
| PBT | C | — | — | 24 | — | 43 |
| Plasticizer | D | 30 | 30 | 30 | | 30 |
| Peroxide (batch) | E | 15 | 15 | 15 | 13 | 15 |
| Co-crosslinker | F | 4 | 4 | 4 | 3 | 4 |
| Stabilization, auxiliary | | | | | | |
| materials and colour: | | | | | | |
| Colour | G | 7 | 7 | 7 | 7 | 7 |
| Additive 1 | | 3 | 3 | 3 | 3 | 3 |
| Additive 2 | | 3 | 3 | 3 | 3 | 3 |
| Fillers | H | 4 | 4 | 4 | | 4 |
| Compatibilizer | I | 10 | 10 | 10 | 10 | 10 |

TABLE 3
Raw materials used

| Raw material | Component | Manufacturer | Type |
|---|---|---|---|
| EVM | A | Lanxess | Levapren ® 600 |
| TPC1 | B | P-Group (So. F. Ter) | Pibiflex ® 4560 |
| TPC2 | | P-Group (So. F. Ter) | Pibiflex ® 56X01 |
| TPC3 | | P-Group (So. F. Ter) | Pibiflex ® 5880 |
| PBT | C | DSM | ARNITE ® T 04 200 |
| Plasticizer | D | Safic Alkan | Edenol ® T810T |
| Peroxide (batch) | E | Pergan | Peroxan ® HXY-10PS |
| Co-crosslinker | F | Kettlitz | Actigran ® 70 |
| Stabilization, auxiliary materials | | | |
| and colour: | | | |
| Colour | G | Evonik Degussa | Colcolor ® EVA 40/60 |
| Additive 1 | | Rhein Chemie | RHENOGRAN ® PCD-50EVA |
| Additive 2 | | Lanxess | VULKANOX ® HS LG |
| Fillers | H | Bayer | ZnO Aktiv |
| Compatibilizer | I | Kometra | EVM ® 600 1% MSA grafted |

TABLE 4
Mechanical values

| Value | Unit | Example 1 | Example 2 | Example 3 | Example 4 | Example 5 |
|---|---|---|---|---|---|---|
| Hardness | ShA | 60 | 74 | 70 | 80 | 80 |
| Tensile strength | N/mm² | 5.5 | 6.7 | 6.9 | 6.5 | 8.6 |
| Elongation at break | % | 273 | 290 | 270 | 270 | 250 |
| Compression set at | % | 65 | 68 | 65 | 67 | 65 |
| 24 h/150° C. | | | | | | |
| Compression set at | % | 57 | 59 | 54 | 57 | 55 |
| 24 h/120° C. | | | | | | |

TABLE 5
Production in a twin-screw extruder

| | | Example 1 | Example 2 | Example 3 | Example 4 | Example 5 |
|---|---|---|---|---|---|---|
| Maximum throughput | Relative | 100 | 90 | 100 | 80 | 100 |
| | to base | | | | | |
| | [%] | | | | | |

TABLE 6
Processing

| | | Example 1 | Example 2 | Example 3 | Example 4 | Example 5 |
|---|---|---|---|---|---|---|
| Max. lifetime at 240° C. in | min | 10 | 2 | 10 | 2 | 10 |
| the injection moulding | | | | | | |
| machine | | | | | | |

TABLE 7
Raw material input

| | | Example 1 | Example 2 | Example 3 | Example 4 | Example 5 |
|---|---|---|---|---|---|---|
| Raw material input | Relative | 100 | 108 | 98 | 102 | 96 |
| | to base | | | | | |
| | [%] | | | | | |

TABLE 8
Compositions

| | | Example 6 | Example 7 | Example 8 | Example 9 | Example 10 |
|---|---|---|---|---|---|---|
| Raw material | Component | phr | phr | phr | phr | phr |
| EVM | A | 100 | 100 | 100 | 100 | 100 |
| TPA1 (“soft” TPA) | B1 | 70 | 45 | 50 | 40 | 30 |
| Polyamide | C | — | — | 10 | 20 | 30 |
| Plasticizer | D | 30 | 25 | 30 | 30 | 30 |
| Peroxide (batch) | E | 13.5 | 13.5 | 13.5 | 13.5 | 13.5 |
| Co-crosslinker | F | 4 | 4 | 4 | 4 | 4 |
| Stabilization, auxiliary | | | | | | |
| materials and colour: | | | | | | |
| Additive 1 | G | 3 | 3 | 3 | 3 | 3 |
| Additive 2 | | 3 | 3 | 3 | 3 | 3 |
| Fillers | H | 4 | 4 | 4 | 4 | 4 |

TABLE 9

| | | Example 11 | Example 12 |
|---|---|---|---|
| Raw material | Component | phr | phr |
| EVM | A | 100 | 100 |
| TPA2 (“hard” TPA) | B2 | 70 | 45 |
| Polyamide | C | — | — |
| Plasticizer | D | 30 | 25 |
| Peroxide (batch) | E | 13.5 | 13.5 |
| Co-crosslinker | F | 4 | 4 |
| Stabilization, auxiliary | | | |
| materials and colour: | | | |
| Additive 1 | G | 3 | 3 |
| Additive 2 | | 3 | 3 |
| Fillers | H | 4 | 4 |

TABLE 10
Raw materials used

| Raw material | Component | Manufacturer | Type |
|---|---|---|---|
| EVM | A | Lanxess | EVM ® 600 |
| TPA1 | B1 | ARKEMA | Pebax ® 4033 |
| TPA2 | B2 | ARKEMA | Pebax ® 7033 |
| PA6 (polyamide) | C | Aquafil (Engineering | AQUAMID ® 6AF |
| | | plastics) | |
| Plasticizer | D | Safic Alkan | Edenol ® T810T |
| Peroxide (batch) | E | Pergan | Peroxan ® HXY-10PS |
| Co-crosslinker | F | Kettlitz | TRIM (ACTIGRAN ® 70) |
| Stabilization, auxiliary materials | | | |
| and colour: | | | |
| Additive 1 | G | Rhein Chemie | RHENOGRAN ® PCD-50EVA |
| Additive 2 | | Lanxess | VULKANOX ® HS LG |
| Fillers | H | Bayer | ZnO Aktiv |

TABLE 11
Mechanical values

| Value | Unit | Example 6 | Example 7 | Example 8 | Example 9 | Example 10 |
|---|---|---|---|---|---|---|
| Hardness | ShA | 57 | 51 | 55 | 61 | 71 |
| Tensile strength | N/mm² | 3.8 | 5.2 | 4.9 | 4.7 | 5.0 |
| Elongation at break | % | 211 | 273 | 272 | 207 | 191 |
| Compression set at | % | 81.1 | 63.0 | 68.0 | 63.5 | 70.5 |
| 24 h/120° C. | | | | | | |

TABLE 12

| Value | Unit | Example 11 | Example 12 |
|---|---|---|---|
| Hardness | ShA | 68 | 79 |
| Tensile strength | N/mm² | 4.5 | 6.5 |
| Elongation at break | % | 151 | 156 |
| Compression set at | % | 72.0 | 80.5 |
| 24 h/120° C. | | | |

TABLE 13

| Measured | | | | Example | | | | |
|---|---|---|---|---|---|---|---|---|
| quantity | Treatment period | Medium | Temperature | 7 | 8 | 9 | 10 | 12 |
| Tensile | Start value | Shell Diesel | 60° C. | 5.2 | 4.9 | 4.7 | 5.0 | 6.5 |
| strength | 3 weeks | | | 2.0 | 2.2 | 2.3 | 3.3 | 3.5 |
| (N/mm²) | | | | | | | | |
| Elongation at | Start value | | | 273 | 272 | 207 | 191 | 156 |
| break (%) | 3 weeks | | | 133 | 155 | 119 | 116 | 81 |

1. A thermoplastic elastomer composition comprising:
a thermoplastic phase (T) and an elastomeric phase (EL),
wherein EL comprises at least one cross-linked or uncross-linked elastomer and T comprises at least one thermoplast (TP) and at least one thermoplastic elastomer (TPE),
wherein TP is a polyester, polyamide or polyurethane and TPE is a TPE based on a copolyester (TPC), a polyamide (TPA) or a polyurethane (TPU), and
wherein a weight ratio EL:T lies in a range of from 100:25 to 100:80.

2. The thermoplastic elastomer composition according to claim 1, wherein the weight ratio EL:T lies in the range of from 100:35 to 100:70.

3. The thermoplastic elastomer composition according to claim 1, wherein T comprises a combination of polyester with TPC or a combination of polyamide with TPA or TPU.

4. The thermoplastic elastomer composition according to claim 1, wherein the composition additionally comprises a cross-linking agent.

5. The thermoplastic elastomer composition according to claim 1, wherein the at least one elastomer of the elastomeric phase is a cross-linked elastomer.

6. The thermoplastic elastomer composition according to claim 1, wherein the TPC has a Shore D hardness in a range of from 36 ShD to 60 ShD and the TPA or TPU has a Shore A hardness in the range of from 60 to 90 ShA.

7. A process for changing the Shore hardness of thermoplastic elastomer compositions without significantly impairing the compression set or the elongation at break or the tensile strength, the process comprising:
producing a thermoplastic elastomer composition having a thermoplastic phase (T) and an elastomeric phase (EL), wherein T comprises a thermoplast (TP) and a thermoplastic elastomer (TPE),
providing a reference composition with a predefined Shore hardness, and
keeping, during the production of the thermoplastic elastomer composition, a weight ratio EL:T the same in comparison with the reference composition, but varying a weight ratio TP:TPE,
wherein a compression set of the thermoplastic elastomer composition, measured after 24 hours at 120° C., is kept no more than 10 percentage points higher, or the tensile strength or elongation at break of the thermoplastic elastomer composition is kept no more than 10 percentage points lower, in each case in comparison with the reference composition.

8. The process according to claim 7, wherein the compression set of the thermoplastic elastomer compositions, measured for 24 hours at 120° C., is kept no more than 5 percentage points higher, or the tensile strength or elongation at break of the thermoplastic elastomer compositions is kept no more than 5 percentage points lower, in each case in comparison with the reference composition.

9. The process according to claim 7, wherein the weight ratio EL:T lies in the range of from 100:25 to 100:80.

10. A process for producing a thermoplastic elastomer composition, comprising:
blending an elastomeric phase (EL) and a thermoplastic phase (T), wherein T comprises at least one thermoplast (TP) and at least one thermoplastic elastomer (TPE), at a temperature above a melting and softening point of TP and TPE,
wherein a weight ratio EL:T lies in the range of from 100:25 to 100:80.

11. The process according to claim 10, wherein the elastomeric phase (EL) is cross-linked during or after the blending with the thermoplastic phase (T).

12. The process according to claim 10, wherein the temperature lies above the melting and softening point in the range of from 150° C. to 350° C.

13. The process according to claim 7, wherein TP is a polyester, a polyamide or a polyurethane.

14. The process according to claim 7, wherein TPE is a TPE based on a copolyester (TPC), a polyamide (TPA) or a polyurethane (TPU).

15. A method for producing a shaped part from a thermoplastic elastomer composition according to claim 1, the method comprising:
preparing the thermoplastic elastomer composition.

16. A shaped part comprising:
the thermoplastic elastomer composition according to claim 1.
